(19) United States
(12) Patent Application Publication
(10) Pub. No.: US 2025/0166502 A1
(43) Pub. Date: May 22, 2025

(54) METHOD FOR REGULATING ROAD TRAFFIC AND DEVICE FOR IMPLEMENTING THE METHOD

(71) Applicant: ORANGE, Issy-Les-Moulineaux (FR)

(72) Inventors: Thierry Gaillet, Chatillon Cedex (FR); Laurent Mussot, Chatillon Cedex (FR); Sylvain Leroux, Chatillon Cedex (FR)

(21) Appl. No.: 18/720,241

(22) PCT Filed: Dec. 14, 2022
(86) PCT No.: PCT/EP2022/085989

§ 371 Date: Jun. 14, 2024

(30) Foreign Application Priority Data
Dec. 16, 2021 (FR) 2113690

(51) Int. Cl. G08G 1/01; G08G 1/0967; G08G 1/0968; H04W 4/44

(52) U.S. Cl. CPC G08G 1/0145; G08G 1/0116; G08G 1/012; G08G 1/0133; G08G 1/096708; G08G 1/096783; G08G 1/0968; H04W 4/44

(57) ABSTRACT

A method for regulating road traffic in which each vehicle of at least one portion of vehicles carries on board a connected device and a user interface connected to the connected device. The method includes: obtaining, from at least the connected devices, at least one datum relating to movement of at least one vehicle of the plurality; identifying a traffic situation based on the data; and based on the identified traffic situation, generating respective recommendation messages to be transmitted to the respective user interfaces, where applicable, each recommendation message including at least one instruction to be adopted by at least one vehicle of the at least one portion of the vehicles and/or by at least one connected device that is not carried on board the vehicles, to streamline the traffic situation. The at least one datum including, for each connected device, a score associated with the connected device.

### TECHNICAL FIELD

The present disclosure relates to the field of road traffic regulation.

### PRIOR ART

Road traffic is subject to major problems such as road congestion and differences in road types, that may, in particular, generate accidents as well as pollution.

Road navigation assistance methods may combine technologies, systems, and connected devices with connectivity solutions in order to generate recommendation messages for connected vehicles, as well as, in the case of autonomous vehicles, to generate instructions enabling semi-autonomous or even completely autonomous driving. In particular, the technologies, systems and connected devices may be chosen from among cameras, radars, lidars, location systems, map data, and driver monitoring systems. The connectivity solutions may, for example, be GPS navigation assistance or solutions implementing 5G.

More specifically, current road navigation assistance methods generally make use of pre-embedded data, which is not always updated regularly. Additionally, “Over-The-Top” route planner services may be used, but these services are not always reliable. Thus, current road navigation assistance methods and Over-the-Top services are most often found to be ineffective in preventing the formation of congestion, particularly in real time.

Consequently, a need to improve road traffic management exists.

### SUMMARY

The present disclosure improves the situation.

The disclosure is based on an approach consisting of considering a portion of connected vehicles progressing within a same road environment and coordinating the actions of the connected vehicles of the portion of vehicles in order to streamline a traffic situation within the road environment.

To this end, a method is proposed for regulating road traffic generated by a plurality of vehicles, implemented by a processing unit connected to a communications network, and based on data issued from devices connected to said communications network, wherein each vehicle of at least one portion of vehicles of the plurality of vehicles carries on board a device connected to the network, as well as a user interface connected to the connected device, the method comprising one or more iterations of a regulation loop, an iteration of the loop comprising:
/a/ obtaining, from at least the connected devices, at least one datum relating to a movement of at least one vehicle of the plurality of vehicles;
/b/ identifying, on the basis of said data, a traffic situation,
/c/ based on the identified traffic situation, generating respective recommendation messages intended to be transmitted to the respective user interfaces, where applicable, each recommendation message comprising at least one instruction to be adopted by at least one vehicle of the at least one portion of the vehicles and/or by at least one connected device that is not carried on board the vehicles, in order to streamline the traffic situation,
   the data obtained in step /a/ further comprising, for each connected device, a score associated with the connected device.

“Vehicle” is understood to refer to a motorized or non-motorized device. For example, the vehicle may be a car, a motorcycle, a truck, a robot, a bicycle, or a scooter. Of course, other vehicles are possible.

“Connected device” is understood to refer to an apparatus equipped with a network communication system. For example, a connected device may be an on-board computer, a mobile telephone, or an electronic component. Furthermore, the connected device may be a connected device of the road infrastructure. For example, the connected device may be a connected traffic stoplight, or a connected road sign. Of course, other connected devices are possible.

In the following description, a connected vehicle may designate a vehicle carrying on board a connected device that may be directly integrated into the vehicle, for example an embedded computer, or not integrated, for example a mobile telephone.

“Traffic situation” is understood to refer to a situation related to a situation among a congestion or non-congestion of a road; a passing of a first vehicle by a second vehicle; a crossing of an intersection; and a combination of these situations. Of course, other traffic situations are possible.

“Recommendation message” may designate an informational message suggesting an instruction to be followed by a user of the user device. Nevertheless, if the connected vehicle is an autonomous vehicle, the recommendation message may be used by vehicle driving software to apply the instruction contained in the recommendation message. For a connected device of the road infrastructure, the recommendation message may be the instruction to be applied by the road infrastructure.

Thus, advantageously, the information may be collected from the connected devices on board the at least one portion of vehicles of the plurality of vehicles.

Additionally or alternatively, the information may be collected from at least one connected device that is not carried on board the vehicles. It is therefore possible, for example, to exploit data collected by the fixed road infrastructure. Data that are in addition to the data exchanged by connected devices on board the vehicles may then be taken into consideration, particularly in the establishment of recommendation messages. Advantageously, when no data are exchanged by the connected devices on board the vehicles, data from the connected device that is not on board the vehicles may enable the traffic situation to be identified.

The traffic situation may then be identified, enabling a generation of recommendation messages in real time. A recommendation message may then be intended for at least one user interface connected to a connected device carried on board a vehicle. Additionally or alternatively, a recommendation message may be intended for at least one connected device that is not carried on board the vehicles, for example a connected infrastructure device or a connected device of a pedestrian. Thus, in certain embodiments, it is possible, based on the identified traffic situation, to select connected vehicles and/or connected devices to which respective recommendation messages are sent in order to streamline the traffic situation. The present description thus enables the information issued from connected devices to be exploited dynamically, which ensures a good level of reliability, in order to streamline the traffic situation. Advantageously, it is possible to affect the connected devices which are or are not carried on board the vehicles, in order to contribute to the streamlining of the traffic situation. Thus, all the elements of the road environment may contribute to streamlining the traffic situation within the road environment, enabling a more effective action.

The score associated with the connected device may, for example, convey a compliance with the instructions in the recommendation messages generated by the user of the user device. According to one example of implementation, the sub-portion of the vehicles for which the respective instructions are generated may thus be defined on the basis of the respective scores. For example, if a user tends to not comply with the instructions in the generated recommendation messages, this user can be removed from the sub-portion of vehicles for which the instructions are defined.

According to another aspect, a computer program is proposed, comprising instructions for the implementation of all or part of a method as defined herein when this program is executed by a processor. According to another aspect, a non-transitory computer-readable storage medium is proposed on which such a program is stored.

According to another aspect, a device is proposed comprising a processing unit configured for the implementation of part or all of a method such as defined herein.

According to another aspect, a connected device is proposed that is connected to a user interface for the implementation, when the connected device is carried on board a vehicle, of one or more iterations of the following steps:
sending at least one datum relating to a movement of the connected device;
receiving, from the processing unit, a recommendation message comprising at least one instruction to be adopted by the vehicle in order to streamline a traffic situation;
transmitting the recommendation message to the user interface.

The features stated in the following paragraphs may optionally be implemented, independently of each other or in combination with each other.

According to one option, on the basis of the identified traffic situation, a calculation phase defining at least the respective instructions to be adopted by at least one sub-portion of the vehicles of the portion of vehicles is executed in order to streamline the traffic situation.

Advantageously, the calculation phase may thus enable the selection, on the basis of the identified traffic situation, of a sub-portion of vehicles of the portion of vehicles for which the respective instructions may be defined. For example, the sub-portion of vehicles may be determined from information related to the road environment or, as described below, on the basis of a behavior of a user of the user device.

According to one option, the at least one datum relating to a movement of at least one vehicle of the plurality of vehicles comprises at least one datum from among a first position of the vehicle, a first direction of the vehicle, a first speed of the vehicle, a first acceleration of the vehicle, and a combination of these data. Of course, other data relating to a movement of the connected device are possible.

Therefore, it may be possible to monitor all of the movements carried out by the vehicles, based on the data obtained from the connected devices.

According to one option, the at least one datum relating to a movement of at least one vehicle of the plurality of vehicles is at least one datum relating to a movement of at least one connected device carried on board a vehicle of the at least one portion of vehicles.

Therefore, it may be possible to monitor all of the movements made by the vehicles carrying connected devices on board, based on easily obtainable data.

According to one option, the at least one instruction comprises at least one instruction from among a route, a value of a second speed, a value of a second acceleration, a braking instruction, an acceleration instruction, a lane change instruction, and a combination of these instructions. Of course, other instructions are possible.

Thus, each user of the respective user device may be informed of specific driving instructions intended to streamline the traffic situation.

According to one option, the data obtained in step/a/further comprise statistical data relating to a road environment of the plurality of vehicles.

“Road environment” is understood to refer to a defined area comprising at least one road. The defined area may be, for example, on the order of tens of meters, hundreds of meters, or several thousands of meters, depending on the target use case. The road environment may comprise all elements situated in the area. The elements may be in motion, for example vehicles, pedestrians, animals; or not in motion, for example infrastructures along the roads, street furniture.

The taking into consideration of statistical data relating to the road environment may enable defining instructions in step/c/which are simultaneously adapted to a current situation within the road environment, while considering more general data that may enhance the data from the calculation phase so as to obtain more detailed instructions.

According to one option, the data obtained in step/a/further comprise, for each connected device, a level of priority associated with the vehicle carrying the connected device on board.

The different types of vehicles carrying connected devices on board may therefore be differentiated. According to one example of implementation, the sub-portion of the vehicles for which the respective instructions are generated may thus be defined on the basis of the respective levels of priority. Furthermore, connected vehicles having a common objective, for example such as a stop at a drop-off point, a wait, or a common exit from a motorway, may be artificially grouped together under a same level of priority in order to generate similar instructions, for a collective operation towards the common objective.

Additionally, according to one option, the respective instructions to be adopted are defined on the basis of the respective levels of priority.

Advantageously, certain priority vehicles, for example such as ambulances or police vehicles, may thus be favored in the establishment of instructions to be adopted. In other words, vehicles with a high level of priority may receive recommendation messages aiming to have them reach a respective objective as fast as possible. Vehicles with a low level of priority may receive recommendation messages aiming to have them reach a respective objective only after allowing vehicles with a high level of priority to reach their respective objectives.

According to one option, the respective scores are modified, where applicable, on the basis of a comparison between the respective instructions generated in step/c/and the respective data obtained in step/a/.

Thus, the respective scores may, for example, be adjusted in real time in order to convey a compliance with the instructions in the generated recommendation messages, according to a feedback loop. A sudden change in behavior of a user may thus be taken into consideration in the creation of instructions.

According to one option, the respective instructions to be adopted are defined on the basis of the respective scores.

The calculation phase may thus be refined on the basis of the users' compliance or non-compliance with the instructions in the generated recommendation messages. Thus, the safety of defined instructions may be increased by targeting users likely to comply with the instructions in the recommendation messages. Furthermore, instructions to the user devices of the sub-portion of vehicles may thus take into consideration the impredictable character of the user who tends not to comply with the instructions in the generated recommendation messages, which again increases the safety of the defined instructions.

According to one option, the method further comprises:
/b1/ feeding a database with data obtained in step/a/and the instructions generated in step/c/,
/b2/ determining the calculation phase based on an artificial intelligence algorithm, wherein the artificial intelligence algorithm is periodically trained on the database.

It is thus possible to adapt the calculation phase according to the data previously observed and to better anticipate the instructions which will enable the traffic to be streamlined. In particular, it is possible to adapt the instructions even before a traffic situation referred to as difficult, for example congestion, is formed.

### BRIEF DESCRIPTION OF THE DRAWINGS

Other features, details and advantages will appear upon reading the detailed description below, and analyzing the attached drawings, in which:

FIG. 1 shows a schematic diagram of a first device for the implementation of the proposed method according to one or more embodiment(s).

FIG. 2 shows a block diagram of a first example of implementation of the proposed method according to one or more embodiment(s).

FIG. 3 shows a block diagram of a second example of implementation of the proposed method according to one or more embodiment(s).

FIG. 4 shows a first example of implementation of the proposed method according to one or more embodiment(s).

FIG. 5 shows a second example of implementation of the proposed method according to one or more embodiment(s).

FIG. 6 shows a third example of implementation of the proposed method according to one or more embodiment(s).

FIG. 7 shows a fourth example of implementation of the proposed method according to one or more embodiment(s).

FIG. 8 represents a diagram of a second device for the implementation of the proposed method according to one or more embodiment(s).

### DESCRIPTION OF EMBODIMENTS

In the different figures, the same references designate identical or similar elements.

In the detailed description below of embodiments of the invention, many specific details are presented to provide a more complete understanding. Nevertheless, the person skilled in the art may realize that some embodiments can be put into practice without these specific details. In other cases, well-known features are not described in detail to avoid unnecessarily complicating the description.

The present description refers to functions, motors, units, modules, platforms, and diagram illustrations of methods and devices according to one or more embodiment(s). Each of the functions, motors, modules, platforms, units, and diagrams described may be implemented as hardware, software (including in the form of embedded software (“firmware”) or (“middleware”)), microcode, or any combination thereof. In the case of implementation as software, the functions, motors, units, modules, and/or diagram illustrations may be implemented by computer program instructions or software code, which may be stored or transmitted on a computer-readable medium, including a non-transitory medium, or a medium loaded into the memory of a generic or dedicated computer, or any other programmable data processing device or apparatus to produce a machine, such that the computer program instructions or software code executed on the computer or apparatus or programmable data processing device constitute means for implementing these functions.

Embodiments of a computer-readable medium include, but are not limited to, computer storage media and communication media, including any media facilitating the transfer of a computer program from one location to another. “Computer storage medium/media” is understood to refer to any physical medium that can be accessed by computer. Examples of computer storage media include, but are not limited to, flash memory discs or components or any other flash memory devices (for example USB keys, memory keys, memory sticks, disk keys), CD-ROMs or other optical data storage devices, DVDs, magnetic disk data storage devices or other magnetic data storage devices, data memory components, RAM, ROM, EEPROM, memory cards (“smart cards”), SSD (“Solid State Drive”) type memories, and any other form of medium usable to transport or store or save data or data structures that can be read by a computer processor.

In addition, various forms of computer-readable media can transmit or carry instructions to a computer, such as a router, gateway, server, or any data transmission device, whether by wired transmission (via coaxial cable, optical fiber, telephone wires, DSL cable, or Ethernet cable), wireless transmission (via infrared, radio, cellular, microwave), or virtualized transmission devices (virtual router, virtual gateway, virtual tunnel endpoint, virtual firewall). Depending on the embodiments, the instructions may comprise code of any computer programming language or computer program element, such as, without limitation, assembly languages, C, C++, Visual Basic, HyperText Markup Language (HTML), Extensible Markup Language (XML), HyperText Transfer Protocol (HTTP), Hypertext Preprocessor (PHP), SQL, MySQL, Java, JavaScript, JavaScript Object Notation (JSON), Python, and Bash scripting.

In addition, the terms “in particular,” “for example,” “example,” “typically” are used in the present description to designate examples or illustrations of non-limiting embodiments which do not necessarily correspond to embodiments that are preferred or advantageous in comparison to other possible aspects or embodiments.

The terms “operatively coupled,” “coupled,” “mounted,” “connected,” and their various variants and forms used in the present description refer to couplings, connections, assemblies, which may be direct or indirect, and in particular comprise connections between electronic devices or between portions of such devices that enable operations and functions as described in the present description. In addition, the terms “connected” and “coupled” are not limited to physical or mechanical connections or couplings. For example, an operative coupling may include one or more wired connections and/or one or more wireless connections between two or more devices which allow simplex and/or duplex communication links between devices or portions of devices. According to another example, an operative coupling or a connection may include a coupling by wired and/or wireless link to enable data communications between a server of the proposed system and another device of the system.

In addition, the present description refers to various data exchanges. In particular, data exchanges may be done via cellular communications according to a generation of standards for mobile telephony, such as second generation, 2G, third generation, 3G, fourth generation, 4G, fifth generation, 5G, or any subsequent generation. Additionally, the present description refers to exchanges of data from and/or to connected vehicles. In this context, data exchanges including a connected vehicle may be governed by standards associated with “Intelligent Transport System, ITS” and with “Vehicle-to-Everything, V2X” domains. In particular, the following standardization bodies: “European Telecommunications Standards Institute, ETSI”; “International Organization for Standardization, ISO”; “European Standardization Committee, ESC”; 3rd Generation Partnership Project, 3GPP″; “Institute of Electrical and Electronics Engineers, IEEE”; and the “Society of Automotive Engineers, SAE”; may govern the current standards in this description. Of course, other standards and other standardization bodies may be considered.

Vehicle-to-Everything, V2X, type communications may, in particular, include “Vehicle-to-Vehicle, V2V” type communications and/or “Vehicle-to-Infrastructure, V2I” type communications and/or “Vehicle-to-Pedestrian, V2P” type communications and/or “Vehicle-to-Network, V2N” type communications. V2V type communications may enable messages to be exchanged between connected vehicles. Message exchanges between connected vehicles, V2V, may, for example, be indications of driving intentions such as, for example, indications of braking or lane changes. V2I type communications may enable interactions with a road infrastructure, for example a connected traffic stoplight. V2P type communications may enable data to be exchanged with pedestrians, which may, for example, allow detecting more vulnerable users who are sharing the road environment. V2N type communications may designate an interaction of the connected vehicle with the cellular network. V2N2x type communications may designate an interaction of the connected vehicle with the cellular network in which the cellular network may also be in interaction with an element x on the basis of the interaction of the connected vehicle with the cellular network. For example, if element x is a second vehicle, a V2N2V type communication may designate indirect interactions between the two vehicles, via the cellular network.

V2N type communications may be associated with a communication mode known as “long range.” In particular, long range mode may be based on the standard generations for mobile telephony and/or on the 3GPP standards.

V2X type communications may be associated with a communication mode known as “short range.” The short range communication mode may be defined on a 5.9 GHZ ITS band from 5855 MHz to 5925 MHz. The short range communication mode may use technologies based, for example, on WiFi and IEEE standards: 802.11p/DSRC/ITS-G5, or be of the optical type, for example according to standards 802.11.bb, 802.15.3 or G.9991.

Additionally or alternatively, the short range communication mode may use technologies based on the cellular network and 3GPP standards; this may be designated by the term C-V2X for “Cellular-V2X,” enabling a direct communication mode using the ITS band, known as “sidelink”.

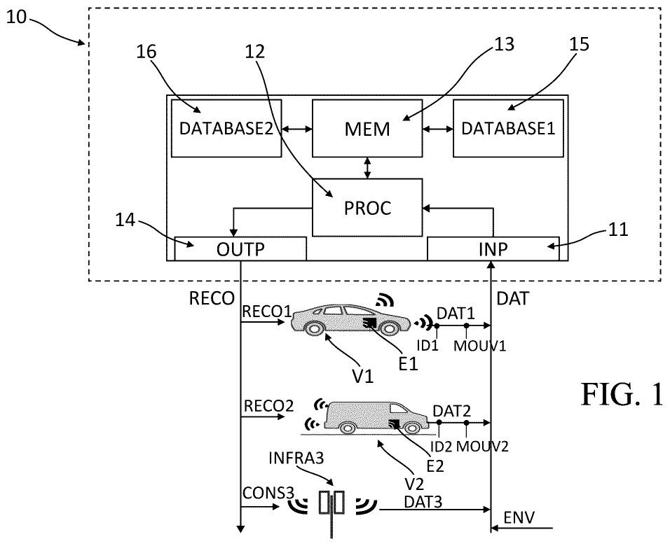

FIG. 1 shows, by way of non-limiting example of road traffic regulating devices, an example of a processing unit 10 according to one or more embodiment(s).

With reference to FIG. 1, a road environment is represented comprising two connected vehicles V1 and V2, as well as a connected device that is not carried on board the vehicles, here an infrastructure device INFRA3 connected to the network. Nevertheless, other vehicles, connected or not, may progress within the represented environment. Furthermore, other infrastructure devices, connected or not, may be present within the represented environment. Alternatively, the road environment may not comprise any connected infrastructure device. The present example should thus be adapted to such situations.

As indicated above, each of vehicles V1 and V2 represented in FIG. 1 carries on board a device connected to the network, respectively E1 and E2, as well as a user interface connected to the connected device E1, E2.

Processing unit 10 is configured to generate a set of recommendation messages RECO to streamline a traffic situation, intended for at least one device E1, E2 connected to the network and carried on board a vehicle V1, V2 and/or for the infrastructure device INFRA3.

Processing unit 10 is connected to a communications network that may be the cellular network.

Processing unit 10 comprises an input interface INP 11, a processor PROC 12, a memory MEM 13 and an output interface OUTP 14.

Input interface INP 11 is configured to receive data DAT. Data DAT comprise at least data DAT1 and DAT2 issued from vehicles V1 and V2 respectively and/or data DAT3 issued from the connected device that is not carried on board the vehicles. Input interface INP 11 from the example of FIG. 1 is, furthermore, configured to receive data ENV relating to the road environment of processing unit 10.

More specifically, input interface INP 11 is configured to receive, from each vehicle V1, V2, data DAT1, DAT2, thus comprising a datum MOUV1, MOUV2 relating to a movement of the connected device E1, E2 as well as, optionally, an identifier ID1, ID2 of the connected device E1, E2 carried on board the vehicle. For example, device E1 may be associated with identifier ID1. Datum MOUV1 relating to a movement of connected device E1 may be a first position of device E1. Alternatively, datum MOUV1 may be a first speed of device E1, a first acceleration of device E1 or a combination of these data. Similarly, device D2 may, for example, be associated with identifier ID2. Datum MOUV2 relating to a movement of connected device E2 may be a first position of device E2, a first speed of device E2, a first acceleration of device E2 or a combination of these data. Datum MOUV1 relating to the movement of connected device E1 may be of the same type as datum MOUV2 relating to the movement of connected device E2, i.e., for example if datum MOUV1 relating to the movement of connected device E1 is a first speed of device E1, datum MOUV2 relating to the movement of connected device E2 may be a first speed of device E2. Alternatively, data MOUV1, MOUV2 relating to the movements of connected devices E1 and E2 may be of different types.

For example, data DAT relating to connected devices may be obtained by means such as a GPS sensor and/or RTK (“Real-Time Kinematic”) and/or SLAM (“Simultaneous Localization and Mapping”) and/or an HD map (“High-definition map”). Of course, other means may be used.

Optionally, each of the data DAT1, DAT2 may comprise a datum with a level of priority associated with vehicle V1, V2 carrying connected device E1, E2 on board. A priority vehicle in the meaning of traffic laws, for example such as a police vehicle or an ambulance, may be associated with a maximum level of priority. A vehicle in a carpooling situation may be associated with a high or even maximum level of priority.

Furthermore, input interface INP 11 is configured to receive, from optional connected infrastructure device INFRA3, data DAT3 specific to connected infrastructure device INFRA3, where applicable. For example, in the case where device INFRA3 is a connected traffic stoplight, data DAT3 may comprise data relating to a traffic light sequence, i.e., a duration of each of the light phases and phase triggering times. Furthermore, data DAT3 may comprise data DAT1, DAT2 relating to connected devices E1, E2.

Input interface INP 11 is, furthermore, configured to receive optional data ENV relating to the road environment of the processing unit 10. Data ENV may, for example, be transmitted by one of the connected devices E1, E2, INFRA3 or by some or all of devices E1, E2 and INFRA3. Each of the connected devices E1, E2 and INFRA3 may or may not transmit a different portion of data ENV. Alternatively, there may be at least partial redundancy in the data transmitted by different connected devices E1, E2, INFRA3. Additionally or alternatively, data ENV may be transmitted, for example by a server, to input interface INP 11 via the cellular network.

Data ENV may, for example, comprise data relating to unconnected vehicles progressing within the road environment. Data relating to unconnected vehicles may, for example, be obtained by a collection of relative information via the connected vehicles or the connected infrastructures. For example, data relating to unconnected devices may be obtained by means such as a lidar sensor and/or an integrated camera. Of course, other means may be used.

Also, data ENV may comprise data from among data concerning the infrastructures present within the road environment, the regulations applied within the road environment, the data concerning a presence of risks within the road environment, and meteorological data. Data concerning infrastructures may, for example, comprise data relating to a presence and/or a position of a speed bump and/or an intersection and/or a traffic circle, to a number of available lanes, to a presence and/or a length of a line crossing. Data concerning applied regulations may, for example, comprise a speed limit. Data concerning a presence of risks may, for example, comprise data relating to risks of landslides, risks of the presence of ice, risks of the passage of animals on the road, risks of a presence of works. Of course, other data relating to the road environment may be received.

According to one embodiment, data ENV furthermore comprise data relating to a geographic area comprising the road environment, i.e., especially a larger area. For example, the geographic area may be on the scale of a neighborhood, a city, or an area comprising a planned route of a vehicle V1, V2 or two vehicles V1 and V2. Data relating to the geographic area may comprise information concerning the road traffic in the geographic area. Data relating to the geographic area may, for the portion of the geographic area that is not the road environment, be rendered anonymous. In this case, vehicles traveling in this area cannot be precisely identified.

In all cases, data ENV may comprise data captured in real time. Additionally, data ENV may comprise statistical data relating to events occurring in the geographic area. For example, statistical data relating to congestion or accidents within the geographic area may be comprised in the data ENV.

In other words, input interface INP 11 may be configured to receive data DAT comprising data issued from a local environment of processing unit 10, here for example via data DAT1, DAT2 and DAT3, as well as data issued from a more general environment, here for example via data ENV, data ENV possibly also comprising data concerning the local environment of processing unit 10.

Processor PROC 12 is operatively coupled to input interface INP 11. Data DAT received by input interface INP 11 are transmitted to the input of processor PROC 12. Processor PROC 12 controls an identification unit, a calculation unit and a recommendation message generation unit. Data DAT received on the input interface INP11 are transmitted to the input of the identification, calculation and recommendation generation units.

The identification unit is configured to identify a traffic situation from data DAT received according to one or more embodiment(s) of the proposed method. The unit is thus able to generate identification data of the traffic situation that are provided to the input of the calculation unit.

The calculation unit is configured to execute a calculation phase based on the identification data of the traffic situation, intended to generate at least one instruction CONS1, CONS2, CONS3 to be adopted by at least one of vehicles V1 and V2 and/or by infrastructure device INFRA3 according to one or more embodiment(s) of the proposed method. The calculation unit is thus able to generate instruction data CONS1, CONS2, CONS3 that are provided to the input of the recommendation message generation unit.

The recommendation message generation unit is configured to generate the set of recommendation messages RECO according to one or more embodiment(s) of the proposed method. The set of recommendation messages RECO may be composed of a single recommendation message from among RECO1 and RECO2, where RECO1 and RECO2 are recommendation messages intended for devices E1 and E2 respectively. Each recommendation message RECO1 and RECO2 comprise at least the instruction CONS1, CONS2. Each recommendation message RECO1, RECO2 may be associated with identifier ID1, ID2 of device E1, E2 respectively. Alternatively, the set of recommendation messages RECO may be composed of recommendations RECO1 and RECO2. Additionally or alternatively, the set of recommendation messages RECO may comprise instruction CONS3 to infrastructure device INFRA3.

Memory MEM 13 is operatively coupled to processor PROC 12. Memory MEM 13 is configured to contain instructions that, when they are executed by processor PROC 12, cause processor PROC 12 to control input INP 11 and output OUTP 14 interfaces as well as the identification, calculation and recommendation generation units and/or to carry out a processing of data from examples of implementation of the proposed method described in the present description. The control instructions of input interface INP 11 may, for example, comprise instructions to ensure the collection of data DAT and the storage of data DAT in memory MEM 13. The control instructions of output interface OUTP 14 may, for example, comprise instructions to ensure the transmission of the set of recommendation messages RECO.

Output interface OUTP 14 is operatively coupled to processor PROC 12. Output interface OUTP 14 is configured to transmit the set of recommendation messages RECO to the connected devices and, in particular, to the corresponding user interfaces, where applicable. For example, in one or more embodiment(s), when the set of recommendation messages RECO comprises a single recommendation message RECO1, output interface OUTP 14 may transmit recommendation message RECO1 to device E1 by identification of identifier ID1 associated with message RECO1.

Processing unit 10 may be a calculator embedded in one of connected devices E1, E2 of vehicles V1, V2. Additionally or alternatively, the processing unit may be a computer, a computer network, an electronic component, or another apparatus comprising processor PROC 12 operatively coupled to memory MEM 13, as well as, depending on the embodiment chosen, a data storage unit, and other associated hardware elements such as a network interface and a media reader for reading a removable storage medium and writing on such a medium (not represented in the figure). The removable storage medium may be, for example, a compact disc (CD), a digital video disc (DVD), a flash disc, a USB key, etc. In particular, processing unit 10 may be implemented in connected infrastructure device INFRA3. Processing unit 10 may alternatively be added to an initially unconnected infrastructure device, for example, a traffic stoplight, a road sign, a fixed speed radar. Of course, other processing units 10 are possible.

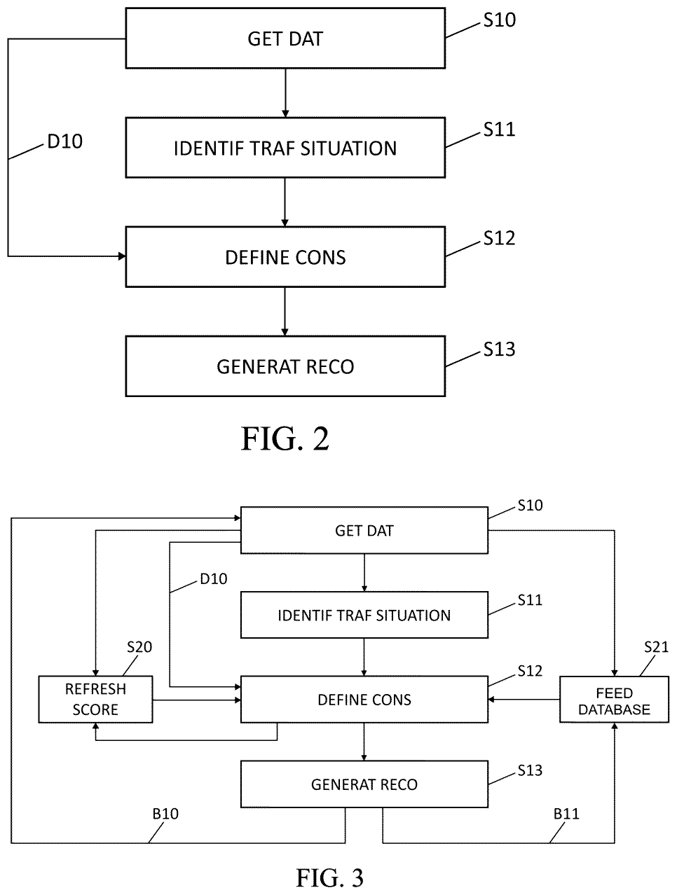

FIG. 2 is a diagram illustrating the proposed method according to one or more embodiment(s).

During a step S10, data DAT are obtained. As previously mentioned, data DAT comprise at least data from among data DAT1 and DAT2 issued from connected vehicles

V1 and V2 and data DAT3 issued from connected infrastructure INFRA3.

According to one embodiment, if processing unit 10 is carried on board one of the connected devices E1, E2, data DAT1, DAT2 may be obtained via a V2V type of communication. Data DAT3 may be obtained via a V2I type of communication.

According to another example of implementation, if processing unit 10 is implemented in connected infrastructure device INFRA3, data DAT1, DAT2 may be obtained via a V2I type of communication.

Alternatively, if processing unit 10 is implemented in a remote server, data may be obtained via a V2N type of communication.

Data DAT1, DAT2 and DAT3 may thus be obtained precisely and dynamically. In particular, data DAT1, DAT2 and DAT3 may be obtained in real time. Data DAT1, DAT2 and DAT3 may be obtained in a continuous flow.

Additional data relating to the road environment ENV may also be obtained via a communication of the V2V, V2I, V2N or cellular type, depending on the implementation of processing unit 10. For example, data ENV may be collected in real time and in particular according to a continuous flow. Alternatively, data ENV may be collected periodically, at an interval that may depend on the type of data ENV. For example, if data ENV refer to information known as “static,” for example concerning infrastructures and/or applied regulations, these data may be collected at an interval that may be daily, weekly, monthly, or even annually. If data ENV refer to information concerning risks, the interval for obtaining information may be fixed at an interval that may be daily, weekly, monthly, or even annually, or may depend on external parameters. For example, when a temperature within the road environment is less than or equal to 0° C., data relating to a risk of ice may be collected in real time.

During a step S11, the identification unit identifies the traffic situation on the basis of data DAT. The traffic situation may be connected to a situation from among congestion or non-congestion of a road; a passing of a first vehicle by a second vehicle; a crossing of an intersection; and a combination of these situations.

According to a first example, the traffic situation may be a state of traffic flow on a road. The state of traffic flow may be identified on the basis of data issued from connected vehicles, in particular. For example, a number of connected vehicles per unit of time within the road environment may be estimated based on data from connected devices. Furthermore, when data ENV comprise data relating to unconnected devices, it is possible to estimate a number of unconnected vehicles per unit of time within the road environment, and then a total number of vehicles, connected or unconnected, per unit of time within the road environment. In this case, the traffic situation may be digital information, for example the number of connected devices per unit of time within the road environment, or, if applicable, the total number of vehicles per unit of time within the road environment. Alternatively, the traffic situation may be binary information on the basis of the number of connected devices per unit of time within the road environment, or, if applicable, the total number of vehicles per unit of time within the road environment. For example, if the number of connected devices per unit of time within the road environment, or, if applicable, the total number of vehicles per unit of time within the road environment, is greater than a threshold value, the traffic situation may be considered to be congested.

According to one or more embodiment(s), during an optional step S12, the calculation unit executes a calculation phase on the basis of the traffic situation identified in step S11. For example, if the traffic situation is identified as congested, the calculation phase may be executed. If the traffic situation is not considered to be congested, the calculation phase may not be executed. The calculation phase aims to define the respective instructions to be adopted by at least one sub-portion of connected vehicles in order to streamline the traffic situation. The sub-portion of vehicles may correspond to all the connected vehicles or to only a portion of the connected vehicles. The instructions to be adopted may be, for each of the vehicles of the sub-portion of vehicles, a route, which may for example be a recommended road, a value of a second speed, a value of a second acceleration, an instruction to slow down or brake, an instruction to accelerate, an instruction to change lanes, an instruction to take a traffic circle, an instruction to park, and a combination of these instructions.

The calculation phase may determine the instructions individually, for each vehicle of the sub-portion of vehicles, in order to streamline the traffic situation of the road environment that applies to all vehicles in the road environment.

The calculation phase may, for example, consist of determining the instructions, for each vehicle of the sub-portion of vehicles, that enable a same objective to be reached. The instructions are thus determined individually according to a collective strategy. The objective is an objective intended to streamline the traffic situation. For example, the objective to be reached may be a total number of vehicles per unit of time in the lane, an average of the estimated times of arrival ETA of all or only one group of vehicles in the road environment, an average of the speeds of all or only one group of vehicles in the road environment. According to certain embodiments, the instructions are determined in view of reaching an optimal, i.e., minimum or maximum, value of the objective. The group of vehicles in the road environment may correspond to connected vehicles as well as to the vehicles for which it is possible to estimate, from data from connected vehicles, at least one parameter such as a speed, a direction, a lane change, for example. Of course, other objectives and/or groups may be considered.

An example of a calculation phase is described below. In this example, it is considered that the group of vehicles from which the value of the objective is estimated comprises N vehicles, with N being a natural number. Each of the N vehicles in the group in question is either a connected vehicle or a vehicle for which at least one parameter as indicated above may be estimated. Here it is considered that the objective is determined from individual objectives OBJi, where OBJi is an individual objective of vehicle i in the group of N vehicles. The individual objective OBJi may be estimated on the basis of data obtained in step S10 as indicated by arrow D10. For example, the individual objective OBJi may be an estimated time of arrival ETAi estimated from a movement datum MOUVi obtained and, optionally, a datum indicating a final destination to be reached. Here it is understood that the index of vehicle i may be connected to the identifier IDI of vehicle i.

In this example, and as described in the equation [Math. 1], the objective is an average of individual objectives. Alternatively, the objective may be a median of individual objectives or another arithmetic function of individual objectives.

$${\overline{OBJ}}_{( C ONS 1 , … , CONSM )} = \frac{1}{N} {\sum }_{i = 1}^{N} {OBJ}_{i} \qquad [ Math . 1 ]$$

Furthermore, here it is considered that the group comprises M connected vehicles, with M∈[[2, N]]. In the interest of simplicity, it is considered that the connected vehicles Vi, i∈[[1, M]] are connected, with, if necessary, renumbering of the vehicles.

Objective OBJi may be weighted on the basis of whether the data taken into consideration in its estimate are directly obtained by the associated connected device Ei, or if these data are estimated by another connected device Ej. For example, for connected vehicle Vi, objective OBJi may be considered to be reliable and be associated with a significant weighting. For an unconnected vehicle Vi, objective OBJi may be considered as less reliable and may be associated with a less significant weighting.

As described in the equation [Math. 2], for each of the vehicles, the objective OBJi depends on the objectives of other vehicles in the group of vehicles, according to a function noted f. Each of the objectives OBJi may also be expressed on the basis of instructions CONS1, . . . , CONSM intended for the connected vehicles. Thus, objective OBJi may be expressed as a function, noted g, of instructions CONS1, . . . , CONSM intended for connected vehicles.

$$∀ i ∈ 〚 1 ; N 〛 , OBJi = f ( OBJ 1 , … , OBJN ) = g ( CONS 1 , … , CONSM ) \qquad [ Math . 2 ]$$

The calculation phase may determine the set of instructions intended for connected vehicles (CONS1*, . . . , CONSM*) such as an optimum of the common objective O̅B̅J̅_{(CONS1, . . . , CONSM)} as seen in the equation [Math.3]. The optimum may be a maximum argument or a minimum argument according to the nature of the common objective. The optimum may, for example, be obtained according to an optimization method such as a gradient algorithm, a Newton method, or any other optimization algorithm.

$$( CONS {1}^{*} , … , {CONSM}^{*} ) = o p {t}_{( C ONS 1 , … , CONSM )} ( {\overline{OBJ}}_{( C ONS 1 , … , CONSM )} ) \qquad [ Math . 3 ]$$

According to certain examples of implementation, as discussed previously, each connected vehicle Vi may be associated with a level of priority δᵢ. The level of priority may be obtained via data DAT according to arrow D10. In these cases, a new individual objective [symbol] Jᵢ may be defined for each connected vehicle Vi by weighting the objective OBJi by the level of priority δᵢ as described in the equation [Math. 4].

$$∀ i ∈ 〚 1 ; M 〛 , {J}_{i} = {δ}_{i} \times OBJi \qquad [ Math . 4 ]$$

A new common objective and a new set of instructions intended for connected vehicles ( [symbol] *, . . . , [symbol] *) may then be defined and estimated as exemplified in equations [Math.5] and [Math.6] respectively. The new set of instructions ( [symbol] *, . . . , [symbol] *) may thus be defined on the basis of the levels of priority.

$${\overline{OBJ}}_{( , … , )} = \frac{1}{N} ( {\sum }_{i = 1}^{M} {J}_{i} + {\sum }_{i = M + 1}^{N} {OBJ}_{i} ) \qquad [ Math . 5 ]$$

$$( {*}^{} , … , {*}^{} ) = o p {t}_{( , … , )} ( {\overline{OBJ}}_{( , … , )} ) \qquad [ Math . 6 ]$$

As previously, the optimum may be a maximum argument or a minimum argument depending on the nature of the common objective. The optimum may, for example, be obtained according to an optimization method such as a gradient algorithm, a Newton method, or any other optimization algorithm. Weighting of the objectives by the levels of priority may enable a new set of instructions ( [symbol] *, . . . , [symbol] *) to be defined, favoring vehicles with the highest levels of priority. For example, if the common objective is the average estimated time of arrival, vehicles with the lowest levels of priority may have their estimated times of arrival delayed so as to advance the estimated times of arrival of vehicles with the highest levels of priority. For example, in terms of recommendation messages generated in step S13, vehicles with the lowest levels of priority may be prompted to slow down and change lanes in order to leave a lane free for vehicles with the highest levels of priority.

Indeed, during step S13, the recommendation message generation unit generates, on the basis of the identified traffic situation, respective recommendation messages intended to be transmitted to infrastructure device INFRA3 and/or for connected devices E1, E2, intended to be transmitted to respective user interfaces. Each recommendation message comprises at least one instruction to be adopted by the connected infrastructure or the vehicle, as applicable, to streamline the traffic situation. Each recommendation message may comprise the identifier of the vehicle, in order to transmit the message to the corresponding user interface. The recommendation message may also comprise information about the collective strategy implemented. For example, the recommendation message may indicate a slowdown instruction to be adopted by first vehicle V1 as well as an objective of this slowdown, for example to enable first vehicle V1 to be passed by second vehicle V2. The recommendation message may be a written message intended to be displayed by a user interface connected to the user device. Additionally or alternatively, the recommendation message may be a voice message intended to be read by the user interface.

According to the example of implementation illustrated in FIG. 2, steps S10, S11, S12 and S13 may be executed sequentially. As illustrated in FIG. 3, steps S10, S11, S12 and S13 may be executed iteratively according to a regulation loop B10. In this case, steps S10, S11, S12 and S13 may be executed sequentially or in parallel. Steps S10, S11, S12 and S13 may be executed in real time.

FIG. 3 represents a diagram illustrating the proposed method according to one or more embodiment(s);

According to the example represented in FIG. 3, several iterations of the regulation loop B10 may be executed. A continuous regulation of the road traffic may be implemented. As previously, the regulation may be executed in real time.

Data DAT obtained during step S10 may furthermore comprise, for each connected device Ei, a score θi associated with connected device Ei. The score θi aims to reflect the following of the instructions in the recommendation messages by the user. A maximum value of the score θi may be associated with a following of instructions in the recommendation messages generated in step S13. A minimum value of the score θi may be associated with a connected device Ei for which the instructions in the recommendation messages generated in step S13 are not followed. Of course, other notation systems may be used.

For example, each score θi may be initialized by default to an intermediate value. Each score θi may be updated according to a score updating step S20. The score updating step S20 may consist of comparing, for each connected device Ei, data Ei obtained in step S10 with the instruction CONSi determined in step S12. On the basis of the data comparison, each score θi may be modified. For example, if data Ei are equal to the instruction CONSi, or are contained in a confidence interval around the instruction CONSi, the score θi may be incremented. The confidence interval may, for example, be a 90% confidence interval, or 95%, or any value of between 90% and 95%. If data Ei are not equal to the instruction CONSi, or are not contained in a confidence interval around the instruction CONSi, the score θi may be decremented.

According to one example of implementation, a user not wishing to follow the instructions in the recommendation messages generated in step S13 may associate his or her connected device Ei with a minimal score. Furthermore, the user may manually adjust his or her score on the basis of a willingness to comply or not comply with the instructions contained in the recommendation messages.

Each instruction CONSi may additionally depend on the scores (θ1, . . . , θM) as expressed in the equation [Math.7]. For example, if the score θi is the minimum score, the connected device Ei may not be associated with an instruction. Indeed, as the minimum score may be associated with repeated non-compliance with the recommended messages, and therefore with the instructions, by user device Ei, it may be considered that the user will not comply with subsequent instructions. Alternatively, an instruction may be associated with a user device Ei with a low reliability weighting, for example identical to the weighting associated with unconnected vehicles.

In this case, the user device Ei may be excluded from the sub-portion of vehicles for which respective recommendation messages are generated. Alternatively, a recommendation message may be generated to user device Ei.

$$∀ i ∈ 〚 1 ; M 〛 , CONSi = \tilde{f} ( ( CONS 1 , θ1 ) , … , ( CONSN , θ M ) ) \qquad [ Math . 7 ]$$

The calculation phase may then depend on the respective scores. Therefore, the set of instructions intended for the connected vehicles (CONS1*, . . . , CONSM*) may depend on the respective scores.

According to one example of implementation, data DAT obtained in step S10 are furthermore recorded in memory MEM 13 in order to feed data to a first database DATABASE 15. The set of instructions intended for the connected vehicles (CONS1*, . . . , CONSM*) may be recorded in memory MEM 13 in order to feed data to a second database DATABASE 16. In other words, second database DATABASE 16 may be fed, according to step S21, with data obtained in step S10 and the instructions generated in step S13.

The first and second databases DATABASE 15, DATABASE 16 may be separate or may be grouped together in a single database. The first and second databases DATABASE 15, DATABASE 16 may be integrated with processing unit 10, as represented in the figure, or stored outside of processing unit 10. First and second databases DATABASE 15, DATABASE 16 may be stored in memory MEM 13.

An artificial intelligence algorithm may be trained on the basis of the data from database DATABASE 15, DATABASE 16.

The artificial intelligence algorithm may be implemented in order to determine the calculation phase S12. The artificial intelligence algorithm may, for example, determine the objective to be reached for the calculation phase. Additionally or alternatively, the artificial intelligence algorithm may determine the set of instructions ( [symbol] *, . . . , [symbol] *).

The artificial intelligence algorithm may, for example, be an algorithm of the random forest type. The artificial intelligence algorithm may be a neural network.

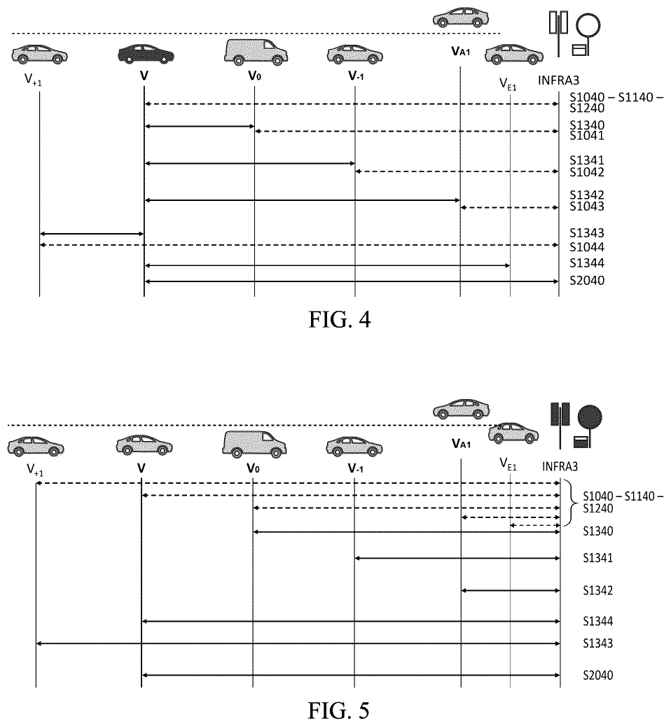

FIG. 4 represents a first example of implementation of the method according to one or more embodiment(s).

In the example represented in FIG. 4, processing unit 10 is carried on board vehicle V. Exchanges of data are mainly done according to communications of the V2V, V2N2V, V2I2V and cellular types. In the interest of simplicity, only the steps necessary for understanding the example are described here.

During a step S1040, data DAT are obtained. Data DAT may refer to vehicles V₊₁, V, V₀, V₋₁, V_{A1} and V_{E1} and to infrastructure INFRA3. Vehicles V₊₁, V₀, V₋₁, V_{A1} and V_{E1}, as well as infrastructure INFRA3, may be connected or unconnected.

In particular, here, data DAT may comprise an absolute speed of the vehicle V, or movement data such as a position and/or acceleration of the connected device associated with vehicle V which allow finding the absolute speed of vehicle V. Data DAT may comprise an absolute speed of vehicle V₀ or, alternatively, a relative speed of vehicle V₀ compared to the absolute speed of vehicle V.

During the phase of identifying the traffic situation S1140, if the absolute speed of vehicle V₀ is not directly known, it may be estimated from the absolute speeds of vehicle V and relative speeds of vehicle V₀. The absolute speed of vehicle V₀ may be compared to the maximum speed within the road environment. If the difference between the absolute speed of vehicle V₀ and the maximum speed is greater than a threshold value, a passing of vehicle V₀ by vehicle V may be contemplated. The threshold value is, for example, twenty kilometers an hour.

If the passing of vehicle V₀ by vehicle V is not contemplated, the processing unit may continue the data collection phase S1040 and carry out the phase of identifying the traffic situation S1140 until the passing is contemplated.

If the passing of vehicle V₀ by vehicle V is contemplated, a duration and a distance of the passing may be calculated during the calculation phase S1240. In this example, the objective of calculation phase S1240 may thus be the passing of vehicle V₀ by vehicle V. In order to define the instructions to the connected vehicles, calculation phase S1240 may take as parameters data relating to the connected vehicles within the road environment as well as the duration and distance of the passing contemplated. Additionally, other data from among a type and a length of the center line where passing, a presence of other unconnected vehicles, a presence of an incline within the environment, a state of the road environment, meteorological data, and a combination of these data may be taken as parameters in the calculation phase.

As the objective of calculation phase S1240 may be the passing of vehicle V₀ by vehicle V, the set of instructions intended for the connected vehicles may aim to temporarily reduce the speed of vehicle V₀, as well as the speed of oncoming vehicle V_{A1}. An instruction to the connected device of vehicle V₋₁ preceding vehicle V₀ may aim to temporarily increase the speed of vehicle V₋₁. The calculation phase may also generate an instruction to the connected device of vehicle V₊₁ such that vehicle V₊₁ follows the passing maneuver of vehicle V₀ by vehicle V. Furthermore, instructions to connected devices of vehicles that are farther away and not directly affected by the maneuver, such as for example V_{E1}, may be generated in order to inform the more distant vehicles, in particular enabling them to adjust their speeds before arriving near the area affected by the maneuver.

For example, according to step S1340, a recommendation message indicating the instruction to temporarily reduce the speed of vehicle V₀, intended for the connected device of vehicle V₀, may be generated.

Optionally, a step S1041 of obtaining data may be implemented. Step S1041 of obtaining data may update data DAT in order to take into consideration whether or not the instruction from the recommendation message was applied by vehicle V₀, and the consequences of the application or non-application of the instruction, particularly on vehicles V₀, V₋₁, V_{A1} and V_{E1}. A new calculation phase may thus be executed and the instructions to connected devices of vehicles may be updated.

During a step S1341, a recommendation message indicating the instruction to temporarily increase the speed of vehicle V₋₁, intended for the connected device of vehicle V₋₁, may be generated.

Optionally, a step S1042 of obtaining data may be implemented. Step S1042 of obtaining data may update data DAT in order to take into consideration whether or not the instruction from the recommendation message was applied by vehicle V₋₁, and the consequences of the application or non-application of the instruction, particularly on vehicles V₋₁, V_{A1} and V_{E1}. A new calculation phase may thus be executed and the instructions to connected devices of the vehicles may be updated.

During a step S1342, a recommendation message indicating the instruction to temporarily reduce the speed of vehicle V_{A1}, intended for the connected device of vehicle V_{A1}, may be generated.

Optionally, a step S1043 of obtaining data may be implemented. Step S1043 of obtaining data may update data DAT in order to take into consideration whether or not the instruction from the recommendation message was applied by vehicle V_{A1}, and the consequences of the application or non-application of the instruction, particularly on vehicles V_{A1} and V_{E1}. A new calculation phase may thus be executed and the instructions to the vehicles may be updated.

During step S1343, a recommendation message to vehicle V₊₁ indicating the instruction, intended for vehicle V₊₁, for vehicle V₊₁ to follow the maneuver of vehicle V, may be generated.

Optionally, a step S1044 of obtaining data may be implemented. Step S1043 of obtaining data may update data DAT in order to take into consideration whether or not the instruction from the recommendation message was applied by vehicle V₊₁, and the consequences of the application or non-application of the instruction, particularly on vehicles V₊₁, V, V₀, V₋₁, V_{A1} and V_{E1}. A new calculation phase may thus be executed and the instructions to the connected devices of the vehicles may be updated.

During step S1344, a recommendation message indicating information on the maneuver of vehicle V, intended for the connected device of vehicle V_{E1}, may be generated.

Vehicle V may then pass or not pass vehicle V₀. Optionally, a step S2040 of obtaining process data may be implemented. Step S2040 of obtaining process data may update the data DAT in order to take into consideration the consequences of the passing of vehicle V₀ by vehicle V on vehicles V, V₀, V₋₁, V_{A1} and V_{E1}.

Data obtained in step S2040 of obtaining process data may be recorded in a database DATABASE 15, DATABASE 16 in order to, for example, enable refining the calculation phase for subsequent uses.

Of course, according to certain examples of implementation, some or all of the steps detailed above may be implemented simultaneously. For example, the steps of generating recommendation messages S1340, S1341, S1342, S1343 and S1344 may be carried out simultaneously. For example, the steps of obtaining data S1040, S1041, S1042, S1043 and S1044 may be carried out simultaneously.

Nevertheless, if vehicle V₀ is not connected, it is not possible to generate directly an instruction to its destination. In this case, as indicated previously, the instructions to connected vehicles are calculated accordingly. For example, if vehicle V₋₁ is connected, the instruction to vehicle V may be an instruction to pass vehicles V₀ and V₋₁. The instruction to vehicle V₋₁ may then be a temporary reduction in the speed of vehicle V₋₁.

If oncoming vehicle V_{A1} is not connected, the traffic situation may be identified as dangerous in step S1140. In this case, recommendation messages to connected vehicles may be a warning about the dangerous situation. The warning may recommend not performing the maneuver in this dangerous situation context.

In the example represented in FIG. 5, processing unit 10 is situated in infrastructure INFRA3. Exchanges of data are mainly done according to V2N and V2I type communications, via the cellular network or road infrastructure. In the interest of brevity of the present description, previously described steps S1040, S1140, S1340, S1341, S1342, S1344, S1343 and S2040 are not described again here. The same references as in FIG. 4 are listed in FIG. 5.

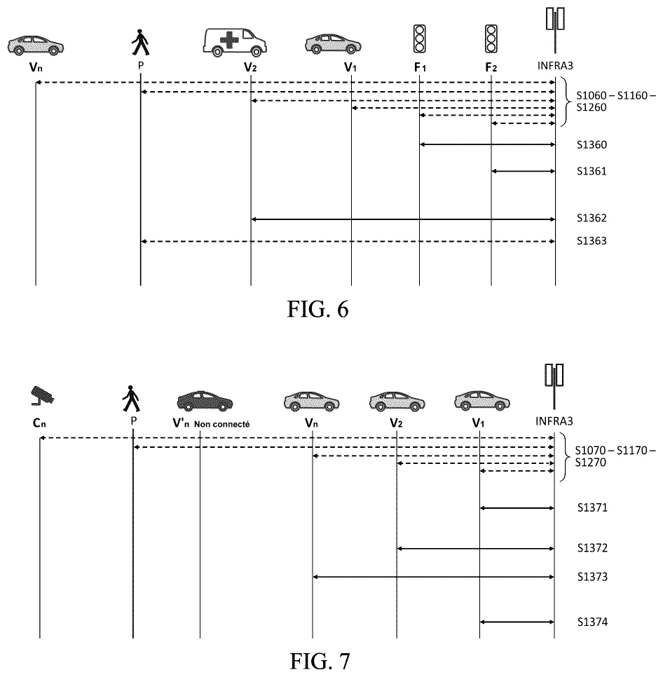

FIG. 6 represents an example of implementation of the method according to one or more embodiment(s).

In the example represented in FIG. 6, processing unit 10 is situated in infrastructure INFRA3. Exchanges of data are mainly done according to V2N and V2I type communications, via the cellular network or road infrastructure. In the interest of simplicity, only the steps necessary for understanding the example are described here.

In the example in FIG. 6, the infrastructures of the road environment comprise two connected traffic stoplights F₁ and F₂. Vehicle V1 may, for example, be found on a first traffic route perpendicular to a second traffic route on which vehicle V2 is driven. The road environment is, for example, an intersection with stoplights F₁ and F₂. Stoplights F₁ and F₂ may respectively be found on the first and second routes. Vehicle V₂ is considered in this example to be a vehicle associated with a high level of priority compared to other vehicles in the road environment.

According to a step S1060, data DAT relating to different devices situated in the road environment, connected or unconnected, are obtained. According to a step S1160, the traffic situation is determined from the obtained data DAT.

The objective of the calculation phase S1260 here may be to reduce an estimated time of arrival of priority vehicle V₂. To do this, the calculation phase S1260 may take as parameters the data relating to the connected vehicles within the road environment as well as the data relating to the connected traffic stoplights. In this case, the set of instructions determined by the calculation phase may comprise instructions intended for the connected vehicles as well as instructions intended for the connected traffic stoplights, which may be determined by adapting the equations [Math. 1] to [Math. 6].

As the objective of the calculation phase S1260 may be to reduce an estimated time of arrival of priority vehicle V₂, the set of determined instructions may aim to clear the second lane of traffic in which priority vehicle V₂ is driven. Thus, an instruction to the traffic stoplight F₁ may aim to trigger, where applicable, a traffic stoplight F₁ phase change, so that the vehicles in the first lane of traffic stop at traffic stoplight F₁. An instruction to traffic stoplight F₂ may aim to trigger, where applicable, a traffic stoplight F₂ phase change, so that the vehicles in the second lane of traffic do not stop at traffic stoplight F₂. An instruction to the connected device of priority vehicle V₂ may thus aim to temporarily increase the speed of vehicle V₂ and/or change lanes. Furthermore, optionally, an instruction to the connected device of pedestrian P may be information on a possible crossing if the pedestrian is near a crosswalk where a traffic stoplight phase has changed and the crosswalk may now be crossed as a result of the phase changes of the connected traffic stoplights F₁ and F₂.

During a step S1360, the instruction to traffic stoplight F₁ may be transmitted.

During a step S1361, the instruction to traffic stoplight F₂ may be transmitted.

During a step S1362, a recommendation message indicating the instruction to the connected device of priority vehicle V₂ may be generated.

Optionally, during a step S1363, a recommendation message comprising the instruction to the connected device of pedestrian P may be generated.

Thus, according to this example, the traffic situation may be dynamically adapted in real time in order to prioritize certain priority vehicles. According to certain embodiments, and as indicated previously, the instructions may be determined by the artificial intelligence algorithm. The phases of the stoplights F₁ and F₂ and the phase triggering times may thus be determined in advance. For example, on the basis of the location and time of day, the traffic stoplight phases may be adapted in advance before a congestion situation occurs.

FIG. 7 represents an example of implementation of the method according to one or more alternative embodiment(s).

According to the example represented in FIG. 7, processing unit 10 is situated in infrastructure INFRA3. Exchanges of data are mainly done according to V₂N and V₂I type communications, via the cellular network or road infrastructure. In the interest of simplicity, only the steps necessary for understanding the example are described here.

In the example of FIG. 7, the road environment comprises, for example, a traffic circle, not represented in the figure. The road environment may comprise a device Cn enabling data relating to the road environment to be obtained. Device Cn is for example a camera situated near the traffic circle.

According to a step S1070, data DAT relating to device Cn, to the connected device of pedestrian P and to the respective connected devices of vehicles Vₙ, V₂ and V₁ are obtained. According to a step S1170, the traffic situation is determined from the obtained data DAT.

The objective of the calculation phase S1270 here may be to ease congestion in the traffic circle. In other words, the objective of the calculation phase may be to reduce the estimated times of arrival of vehicles V′ₙ, Vₙ, V₂ and V₁.

The set of instructions to the connected devices of connected vehicles Vₙ, V₂ and V₁ may thus comprise instructions aiming to simulate traffic stoplights. For example, if vehicle V₁/Vₙ is situated at the periphery of the traffic circle at a first/nth entrance to the traffic circle, an instruction for vehicle V₁/Vₙ to temporarily stop may be generated even though it is possible for vehicle V₁/Vₙ to enter a ring of the traffic circle, in order to unblock the traffic circle before vehicle V₁/Vₙ enters the ring of the traffic circle. If vehicle V₂ is situated at the periphery of the traffic circle at a second entrance of the traffic circle, an instruction for vehicle V₂ to enter the traffic circle may be generated.

Thus, according to a step S1371/S1373, a recommendation message indicating an instruction to slow down and stop may be generated for the connected device of connected vehicle V₁/Vₙ.

According to a step S1372, a recommendation message indicating an instruction to enter may be generated for the connected device of connected vehicle V₂.

According to a step S1374, a recommendation message indicating an instruction to enter may be generated for the connected device of connected vehicle V₁.

Thus, according to this example, the traffic situation may be dynamically adapted in real time in order to ease congestion in the traffic circle. According to certain embodiments, the instructions may be determined by the artificial intelligence algorithm in order to adapt the virtual traffic stoplight instructions in advance and prevent congestion from being formed.

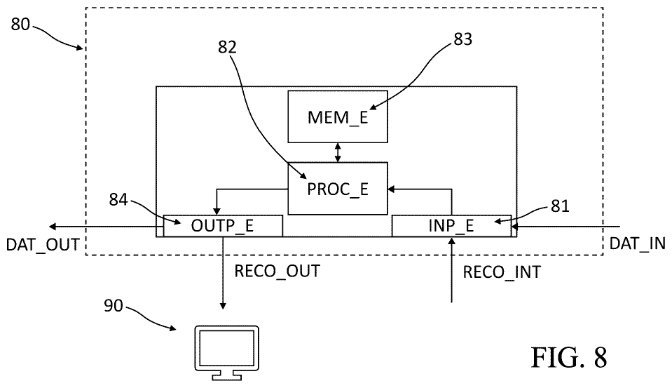

FIG. 8 represents an example of a connected device 80 for the implementation of the method of the present description according to one or more embodiment(s).

Connected device 80 is connected to the communications network.

Connected device 80 comprises an input interface INP_E 81, a processor PROC_E 82, a memory MEM_E 83 and an output interface OUTP_E 84. Connected device 80 is, for example, a computer carried on board a vehicle. Alternatively, connected device 80 may be a mobile telephone, an electronic component, or another apparatus comprising processor PROC_E 82.

Input interface INP_E 81 is configured to receive data DAT_IN captured within the road environment. Data DAT_IN may be captured by a sensor integrated or not integrated into user device 80. For example, the sensor may be a GPS sensor, an RTK sensor, a lidar sensor, an integrated camera, or a combination of these sensors. Of course, other sensors may be contemplated.

Input interface INP_E 81 is furthermore configured to receive recommendation messages RECO_IN intended for connected device 80.

Processor PROC_E 82 is operatively coupled to input interface INP_E 81. Data DAT_IN and recommendation messages RECO_IN received by input interface INP_E 81 are transmitted to the input of processor PROC_E 82.

Memory MEM_E 83 is operatively coupled to processor PROC_E 82. Memory MEM_E 83 is configured to contain instructions that, when executed by processor PROC_E 82, cause processor PROC_E 82 to control input INP_E 81 and output OUTP_E 84 interfaces. The control instructions for input interface INP_E 81 may, for example, comprise instructions to ensure the collection of data DAT_IN and recommendation messages RECO_IN and the storage of data DAT_IN and recommendation messages RECO_IN in memory MEM_E 83. The collection of data DAT_IN may be done periodically. The collection period may be set by processor PROC_E 82. The collection period may depend on data DAT_IN. The control instructions for output interface OUTP 14 may, for example, comprise instructions to ensure the transmission of data DAT_OUT to processing unit 10. Data DAT_OUT may be equal to data DAT_IN. Alternatively, processor PROC_E 82 may carry out filtering of data DAT_IN. In this case, data DAT_OUT may, for example, be data deemed relevant among data DAT_IN. A criterion of relevance is, for example, a comparison to a threshold. Additionally or alternatively, data DAT_OUT may correspond to a packet of data

DAT_IN. Data DAT_OUT may be transmitted periodically to processing unit 10. The transmission period of data DAT_OUT may depend on the type of data DAT_OUT.

Furthermore, connected device 80 may be operatively connected to user interface 90. User interface 90 may be integrated into connected device 80. Alternatively, user interface 90 may be separate from connected device 80. For example, user interface 90 may be a display screen and/or a speaker.

Thus, the control instructions for output interface OUTP 14 may, for example, comprise recommendation messages RECO_OUT intended for user interface 90. Recommendation messages RECO_OUT may be equal to recommendation messages RECO_IN. Alternatively, processor PROC_E 82 may process recommendation messages RECO_IN in order to adapt recommendation messages RECO_IN to user interface 90. Recommendation message RECO_IN may then be a written message intended to be displayed by user interface 90. Additionally or alternatively, the recommendation message may be a voice message intended to be read by user interface 90.

The present disclosure is not limited to the examples described above only by way of example, but encompasses all the variants that a person skilled in the art may envisage within the context of the protection sought.

1. A method comprising:
regulating road traffic generated by a plurality of vehicles, implemented by a processing unit connected to a communications network, and based on data issued from devices connected to said communications network,
wherein each vehicle of at least one portion of vehicles of the plurality of vehicles carries on board a device connected to the network, as well as a user interface connected to the connected device,
the regulating comprising one or more iterations of a regulation loop, an iteration of the loop comprising:
obtaining, from at least the connected devices, at least one datum relating to a movement of at least one vehicle of the plurality of vehicles;
identifying, on the basis of said data, a traffic situation; and
based on the identified traffic situation, generating respective recommendation messages intended to be transmitted to the respective user interfaces, where applicable, each recommendation message comprising at least one instruction to be adopted by at least one vehicle of the at least one portion of the vehicles and/or by at least one connected device that is not carried on board the vehicles, in order to streamline the traffic situation,
the at least one datum obtained furthermore comprising, for each connected device, a score associated with the connected device.

2. The method according to claim 1, furthermore comprising:
on the basis of the identified traffic situation, executing a calculation phase defining at least the respective instructions to be adopted by at least one sub-portion of the vehicles of the portion of vehicles, in order to streamline the traffic situation.

3. The method according to claim 1, wherein the at least one datum relating to a movement of at least one vehicle of the plurality of vehicles comprises at least one datum from among a first position of the vehicle, a first direction of the vehicle, a first speed of the vehicle, a first acceleration of the vehicle, and a combination of these data.

4. The method according to claim 3, wherein the at least one datum relating to a movement of at least one vehicle of the plurality of vehicles is at least one datum relating to a movement of at least one connected device carried on board a vehicle of the at least one portion of vehicles.

5. The method according to claim 1, wherein the at least one instruction comprises at least one instruction from among a route, a value of a second speed, a value of a second acceleration, a braking instruction, an acceleration instruction, a lane change instruction, and a combination of these instructions.

6. The method according to claim 1, wherein the at leas one datum obtained further comprises statistical data relating to a road environment of the plurality of vehicles.

7. The method according to claim 1, wherein the at least one datum obtained further comprises, for each connected device, a level of priority associated with the vehicle carrying the connected device on board.

8. The method according to claim 7, wherein the respective instructions to be adopted are defined on the basis of the respective levels of priority.

9. The method according to claim 1, wherein the respective scores are modified, where applicable, on the basis of a comparison between the respective instructions generated and the respective at least one datum obtained.

10. The method according to claim 1, wherein the respective instructions to be adopted are defined on the basis of the respective scores.

11. The method according to claim 1, further comprising:
feeding a database with the at least one datum obtained and the instructions generated,
determining the calculation phase based on an artificial intelligence algorithm, wherein the artificial intelligence algorithm is periodically trained on the database.

12. A non-transitory storage medium comprising instructions which, when executed by a processing unit connected to a communications network, cause the processing unit to implement a method for regulating road traffic generated by a plurality of vehicles, based on data issued from devices connected to said communications network,
wherein each vehicle of at least one portion of vehicles of the plurality of vehicles carries on board a device connected to the network, as well as a user interface connected to the connected device,
the method comprising one or more iterations of a regulation loop, an iteration of the loop comprising:
obtaining, from at least the connected devices, at least one datum relating to a movement of at least one vehicle of the plurality of vehicles;
identifying, on the basis of said data, a traffic situation; and
based on the identified traffic situation, generating respective recommendation messages intended to be transmitted to the respective user interfaces, where applicable, each recommendation message comprising at least one instruction to be adopted by at least one vehicle of the at least one portion of the vehicles and/or by at least one connected device that is not carried on board the vehicles, in order to streamline the traffic situation,
the at least one datum obtained furthermore comprising, for each connected device, a score associated with the connected device.

13. A device comprising a processing unit configured for the implementation of the method according to claim 1.

14. A connected device connected to a user interface for the implementation, when the connected device is carried on board a vehicle, of one or more iterations of:
sending a datum relating to a movement of the connected device and a score associated with the connected device;
receiving, from a processing unit, a recommendation message comprising at least one instruction to be adopted by the vehicle in order to streamline a traffic situation; and
transmitting the recommendation message to the user interface.
